(19) United States
(12) Patent Application Publication
(10) Pub. No.: US 2021/0405822 A1
(43) Pub. Date: Dec. 30, 2021

(54) Touch Electrode Unit, Touch Panel, and Touch Display

(71) Applicant: Wuhan China Star Optoelectronics Semiconductor Display Technology Co., LTD., Wuhan, Hubei (CN)

(72) Inventor: Xiaoliang FENG, Wuhan, Hubei (CN)

(73) Assignee: Wuhan China Star Optoelectronics Semiconductor Display Technology Co., LTD., Wuhan, Hubei (CN)

(21) Appl. No.: 16/485,436

(22) PCT Filed: Jan. 14, 2019
(86) PCT No.: PCT/CN2019/071566

§ 371 Date: Aug. 12, 2019

(30) Foreign Application Priority Data
Dec. 5, 2018 (CN) 201811478293.9

(51) Int. Cl. G06F 3/044

(52) U.S. Cl. CPC G06F 3/0448; G06F 3/0446

(57) ABSTRACT

A touch electrode unit, a touch panel, and a touch display are provided. The touch electrode unit includes at least one trunk wire; a plurality of island portions distributed evenly around at least one of two sides of the trunk wire; a plurality of branch wires connecting the island portions to each other and connecting the trunk wire to a part of the island portions close to the trunk wire, wherein a plurality of hollow portions are formed between the branch wires, the island portions, and the trunk wire.

### FIELD OF INVENTION

The present disclosure relates to the technical field of capacitive touch devices, and specifically to a touch electrode unit, a touch panel, and a touch display.

### BACKGROUND OF INVENTION

Currently, touch technology becomes an important function of a display product. As display accuracy becomes gradually higher, requirements for touch technology gradually increase. Taking projected capacitive touch technology as an example, that it can be divided into self-capacitance and mutual capacitance types.

Taking a mutual capacitive display as an example, a touch electrode structure is formed by a plurality of driving electrodes and a plurality of sensing electrodes, which are both connected in series and are arranged in an interlaced array each other. When a touch behavior is detected, mutual capacitance at a touched point between one of the driving electrodes and one of the sensing electrodes is changing. Coordinates of a touch point can be obtained by scanning a capacitance variation in a two-dimensional plane of a display.

However, the mutual capacitance of a conventional touch electrode pattern is relatively large. During a response process of a touch signal, charging, and discharging time of the mutual capacitance is relatively long, resulting in that a touch response is not fast enough and a touch experience is poor. In the past, although some technologies have tried to solve the above problems, the problems still need to be improved.

Therefore, the prior art has drawbacks and is needed to be improved urgently.

### SUMMARY OF INVENTION

The present disclosure provides a touch electrode unit, a touch panel, and a touch display to solve the above problem in the prior art.

An aspect of the present disclosure provides a touch electrode unit, which includes at least one trunk wire; a plurality of island portions distributed evenly around at least one of two sides of the trunk wire; and a plurality of branch wires connecting the island portions to each other and connecting the trunk wire to a part of the island portions close to the trunk wire, wherein a plurality of hollow portions are formed between the branch wires, the island portions, and the trunk wire.

In some embodiments, a number of the at least one trunk wire is two or more, and the two or more trunk wires cross each other at a central point.

In some embodiments, the number of the at least one trunk wire is two, the two trunk wires extend in two directions perpendicular to each other, the two trunk wires cross at the central point to define four layout areas, and the island portions are distributed evenly within the layout areas.

In some embodiments, each of the branch wires extends along one of the two directions.

In some embodiments, each of the layout areas is a triangular layout area having a right angle toward the central point.

In some embodiments, the island portions are distributed in an array manner within the triangular layout areas.

In some embodiments, a number of the island portions arranged along one of the two directions is gradually decreasing in the other of the two directions away from the central point.

In some embodiments, each of the island portions is formed into a solid block shaped as a regular polygon.

In some embodiments, each of the island portions is formed into a regular quadrilateral and has four right angles, and at least one of two ends of the branch wires is connected between adjacent two of the right angles of each of the island portions.

In some embodiments, a length of each of four edges of each of the island portions formed as the regular quadrilateral is greater than a width of each of the branch wires, and the width of each of the branch wires is less than a width of the trunk wire.

In some embodiments, the trunk wire, the island portions, and the branch wires are formed of a transparent conductive material.

Another aspect of the present disclosure provides a touch panel, which includes a plurality of touch electrode units as mentioned above, wherein the touch electrode units are connected in series to form a plurality of first electrode strings and a plurality of second electrode strings, the first electrode strings are arranged in parallel along a first direction, the second electrode strings are arranged in parallel along a second direction perpendicular to the first direction, and the touch electrode units in the first electrode strings and the touch electrode units in the second electrode strings are arranged in an interlaced manner and insulated from each other; and

wherein one of the touch electrode units includes:
at least one trunk wire;
a plurality of island portions distributed evenly around at least one of two sides of the trunk wire; and
a plurality of branch wires connecting the island portions to each other and connecting the trunk wire to a part of the island portions close to the trunk wire, wherein a plurality of hollow portions are formed between the branch wires, the island portions and the trunk wire.

In some embodiments, a number of the at least one trunk wire is two or more, and the two or more trunk wires cross each other at a central point.

In some embodiments, the number of the at least one trunk wire is two, the two trunk wires extend in two directions perpendicular to each other, the two trunk wires cross at the central point to define four layout areas, and the island portions are distributed evenly within the layout areas.

In some embodiments, each of the branch wires extends along one of the two directions.

In some embodiments, each of the layout areas is a triangular layout area having a right angle toward the central point.

In some embodiments, the island portions are distributed in an array manner within the triangular layout areas.

In some embodiments, a number of the island portions arranged along one of the two directions is gradually decreasing in the other of the two directions away from the central point.

In some embodiments, each of the island portions is formed into a solid block shaped as a regular polygon.

Another aspect of the present disclosure provides a touch display, which includes the touch panel as mentioned above.

Compared with the prior art, the touch electrode unit, the touch panel, and the touch display of the present disclosure are implemented by forming a large number of uniformly distributed hollow portions between the branch wires, the island portions, and the trunk wire. It can effectively reduce a contact area of the touch electrode unit, such that the mutual capacitance is reduced during the touch process, thereby shortening response time of charge and discharge during the touch process. Thus, a response speed of the touch process is effectively improved, thereby optimizing the touch experience.

### BRIEF DESCRIPTION OF DRAWINGS

FIG. 1 is a schematic diagram of a plan view showing a plurality of electrode strings formed in series by a plurality of touch electrode units according to an embodiment of the present disclosure.

FIG. 2 is a schematic diagram of the electrode strings of FIG. 1 and is drawn in an obliquely upward visual angle for an illustration of mutual capacitance.

FIG. 3 is a schematic diagram of a plurality of electrode strings formed by a plurality of touch electrode units connected in series without hollow portions and is drawn in an obliquely upward visual angle for an illustration of another mutual capacitance.

FIG. 4a is a schematic diagram of touch response time of the mutual capacitance in FIG. 3.

FIG. 4b is a schematic diagram of touch response time of the mutual capacitance in FIG. 2.

### DETAILED DESCRIPTION OF PREFERRED EMBODIMENTS

The following description of the various embodiments is provided to illustrate the specific embodiments of the present disclosure. Furthermore, directional terms mentioned in the present disclosure, such as upper, lower, top, bottom, front, rear, left, right, inner, outer, side, surrounding, central, horizontal, lateral, vertical, longitudinal, axial, radial, uppermost or lowermost, etc., which only refer to the direction of drawings. Therefore, the directional terms used as above are for the purpose of illustration and understanding of the present disclosure, and are not intended to limit the present disclosure.

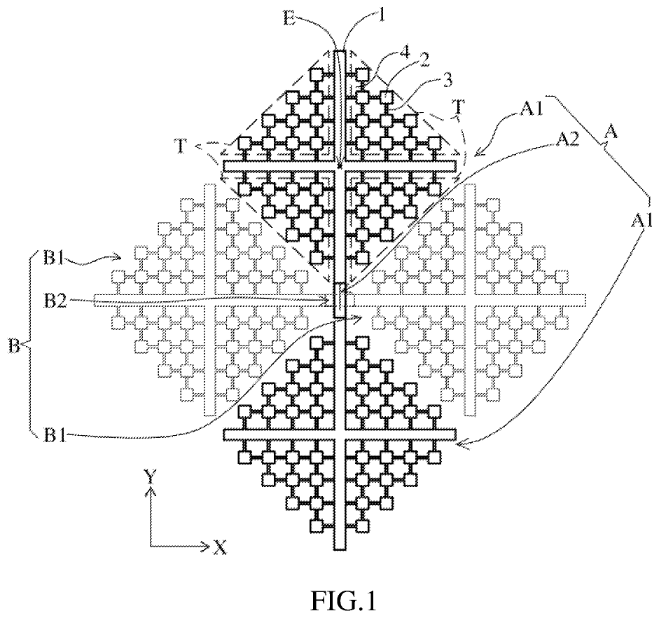

Please refer to FIG. 1, a touch electrode unit according to an embodiment of the present disclosure may include at least one trunk wire 1; a plurality of island portions 2 that are distributed evenly around at least one of two sides of the trunk wire 1; and a plurality of branch wires 3 that are connecting the island portions 2 to each other and are connecting the trunk wire 1 to a part of the island portions 2 close to the trunk wire 1, wherein a plurality of hollow portions 4 are formed between the branch wires 3, the island portions 2, and the trunk wire 1.

In some embodiments, the trunk wire 1, the island portions 2, and the branch wires 3 are formed of a transparent conductive material, such as indium tin oxide (ITO).

In some embodiments, a number of the trunk wire 1 may be one, and the island portions 2 may be evenly distributed around one side or two sides of the trunk wire 1, wherein the two sides are located between two ends of the trunk wire 1. In addition, the number of the trunk wire 1 may also be two or more, and the two or more trunk wires 1 may also cross each other at a central point E. In order to simplify the description, two of the trunk wires 1 are taken as an example as following, but that are not limited as described here.

For example, if the number of the trunk wires 1 is two, the two trunk wires 1 may extend in two directions X and Y perpendicular to each other. The two trunk wires 1 cross at the central point E to define four layout areas T. The island portions 3 are distributed evenly within the layout areas T. Each of the branch wires 3 may extend along one of the two directions X and Y. In some embodiments. Each of the layout areas T is a triangular layout area, which has a right angle toward the central point E. Thus, a distribution area occupied by the trunk wires 1, the island portions 2, and the branch wires 3 may be shaped as a rhombus region to improve density of an interlaced arrangement of the touch electrode units.

Specifically, the island portions 2 may be evenly distributed within the triangular layout areas T, each of the branch wires 3 extends along one of the two directions X and Y, such that the hollow portions 4 are formed between the branch wires 3, the island portions 2, and the trunk wire 1. Thus, an area of the touch electrode unit is greatly reduced. In addition, a shape of the hollow portion 4 may be changed depending on its position, such as forming into a convex shape or a cross shape.

In some embodiments, the island portions 2 are distributed in an array manner within the triangular layout areas T. For example, the island portions 2 may be arranged in a plurality of rows and a plurality of columns, wherein a row spacing and a column spacing may be identical, such that the island portions 2 are evenly arranged within the layout areas T. Thus, it can effectively reduce an area to be contacted without reducing the overall touch range.

In some embodiments, each of the island portions 2 is formed into a solid block shaped as a regular polygon, such as a regular quadrilateral or a regular octagon, wherein a number of edges of the regular polygon may be a multiple of four. Thus, the island portions 2 can be assisted to connect the branch wires 3. As shown in FIG. 1, the regular quadrilateral is taken as an example, each of the island portions 2 is formed to a regular quadrilateral and has four right angles, and at least one of two ends of the branch wires 2 is connected between adjacent two of the right angles of each of the island portions 2. Thus, the touch effect can be effectively maintained without being affected by the reduced area to be contacted.

In some embodiments, a number of the island portions 2 arranged along one of the two directions, such as the direction X, is gradually decreasing in the other of the two directions, such as the direction Y, away from the central point E. Taking one touch electrode unit A1 shown in FIG. 1 as an example, within the layout area T in an upper right direction defined by two trunk wires 1, the number of the island portions 2 arranged along the direction X is gradually decreasing from four to three, two, and one, in the direction Y away from the central point E. Thus, uniformity of distribution of both the island portions 2 and the hollow portions 4 can be effectively improved.

In some embodiments, a length of each of four edges of each of the island portions 2 is greater than a width of each of the branch wires 3, and the width of each of the branch wires 3 is less than a width of the trunk wire 1. Thus, a distribution area of the hollow portions 4 can be effectively expanded to reduce a contact area of the touch electrode unit and to maintain that the touch effect that is unaffected.

As shown in FIG. 1, a plurality of above touch electrode units may be connected in series to form a plurality of electrode strings in order to apply to a touch panel. The following examples are given, but are not limited as described here.

For example, the touch panel may include the above touch electrode units. The touch electrode units may be connected in series to form a plurality of first electrode strings A and a plurality of second electrode strings B. The first electrode strings A may include a plurality of touch electrode units A1, and adjacent two of the touch electrode units A1 may be connected in series via a conductive member A2, such as indium tin oxide (ITO). Similarly, the first electrode strings B may include a plurality of touch electrode units B1, and adjacent two of the touch electrode units B1 may be connected in series via another conductive member B2, such as ITO. The first electrode strings A are arranged in parallel along a first direction, the second electrode strings B are arranged in parallel along a second direction perpendicular to the first direction, and the touch electrode units A1 in the first electrode strings A and the touch electrode units B1 in the second electrode strings B are arranged in an interlaced manner and insulated from each other.

For example, the touch electrode units A1 and B1 may be disposed on the same plane for manufacturing a single layered ITO (SITO) type mutual capacitive touch panel, and the shape of the touch electrode units A1 and B1 at the edge of the touch panel may be changed in accordance with actual requirements.

In addition, the touch panel may be applied to a touch display, which may include the above touch panel and further include a display panel, such as a liquid crystal display (LCD) display panel or an organic light emitting diode (OLED) display panel.

In order to explain the advantages of the above-described embodiments of the present disclosure, a plurality of electrode strings formed by a plurality of touch electrode units connected in series without the hollow portions are discussed as a comparison object.

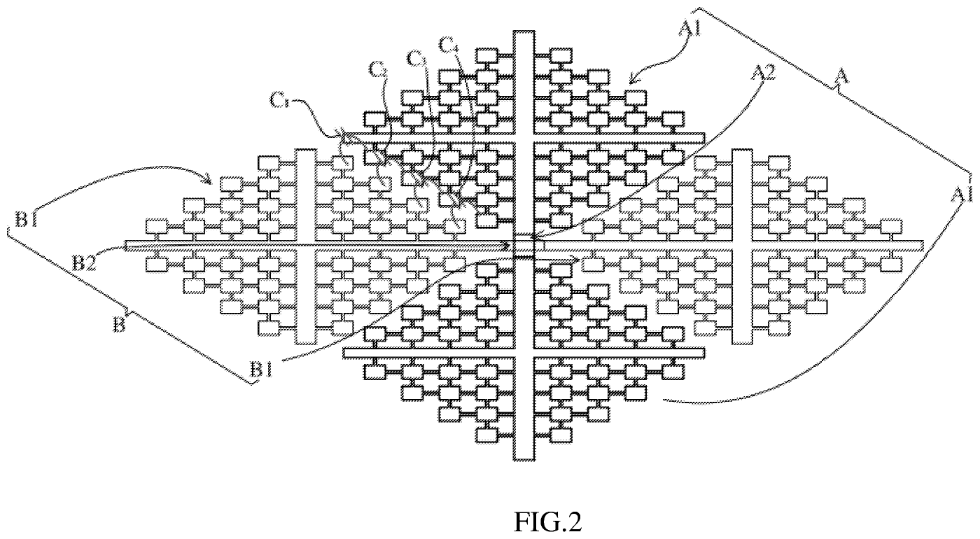

First, as shown in FIG. 1, because the hollow portions 4 are distributed between the adjacent two of the island portions 2 of the touch electrode units A1 and B1, the overall area of the touch electrode units A1 and B1 can be greatly reduced, and areas of the touch electrode units P1 and K1 are related to the size of the mutual capacitance. In addition, as shown in FIG. 2, an overall mutual capacitance between the adjacent two of touch electrode units A1 and B1 may be composed of a plurality of local mutual capacitance, such as C₁, C₂, C₃, and C₄ between a plurality of sets of the adjacent island portions 2. During a power-on operation process, the mutual capacitance between the touch electrode units A1 and B1 having the hollow portion 4 can be reduced.

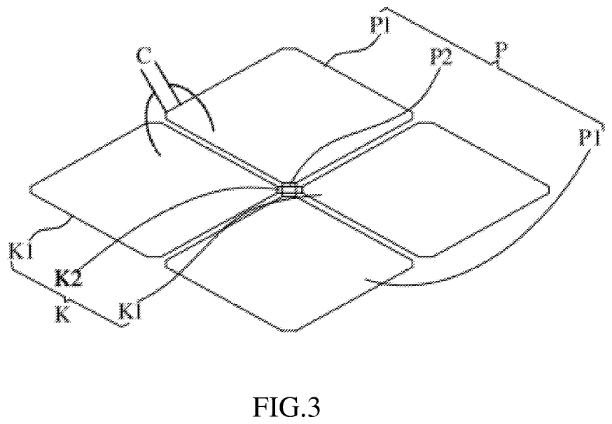

By comparison, as shown in FIG. 3, in two electrode strings P and K, a plurality of touch electrode units P1 are connected in series by a conductive member P2, a plurality of touch electrode units K1 are connected in series by a conductive member K2. The touch electrode units P1 and K1 are both filled up a diamond-shaped area (i.e., there are no hollow portions), the touch electrode units P1 and K1 have a large overall area, and mutual capacitance C between the touch electrode units P1 and K1 is also large.

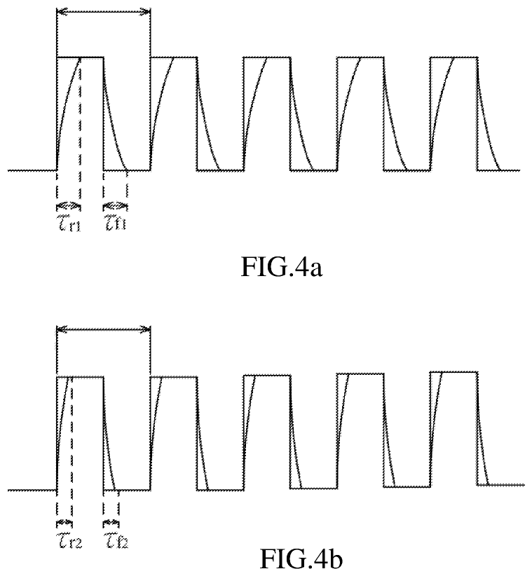

Since a size of the mutual capacitance is related to response time of charging and discharging during a touch process, in a cycle of charging and discharging, compared with touch response time τᵣ₁, τ_{f1} (as shown in FIG. 4a) of the touch electrode units P1 and K1 having no the hollow portions, response time τᵣ₂, τ_{f2} (as shown in FIG. 4b) of the touch electrode units A1 and B1 having the hollow portions are obviously shorter. Thus, the above-mentioned touch electrode units A1 and B1 with the uniformly distributed hollow portion 4 can effectively improve the response speed of the touch process, thereby optimizing an experience of the touch process.

Therefore, the touch electrode unit, the touch panel, and the touch display of the present disclosure are implemented by forming a great number of uniformly distributed hollow portions between the branch wires, the island portions, and the trunk wire that can effectively reduce a contact area of the touch electrode unit, such that the mutual capacitance is reduced during the touch process, thereby shortening response times of charging and discharging during the touch process. Thus, a response speed of the touch process is effectively improved, thereby optimizing the touch experience.

In the above, although the present application has been disclosed in the above preferred embodiments, the preferred embodiments are not intended to limit the application. Various changes and modifications can be made by those skilled in the art without departing from the spirit and scope of the application. Thus, the scope of protection of this application is subject to the scope defined by the claims

What is claimed is:

1. A touch electrode unit, comprising:
at least one trunk wire;
a plurality of island portions distributed evenly around at least one of two sides of the trunk wire; and
a plurality of branch wires connecting the island portions to each other and connecting the trunk wire to a part of the island portions close to the trunk wire, wherein a plurality of hollow portions are formed between the branch wires, the island portions, and the trunk wire.

2. The touch electrode unit as claimed in claim 1, wherein a number of the at least one trunk wire is two or more, and the two or more trunk wires cross each other at a central point.

3. The touch electrode unit as claimed in claim 2, wherein the number of the at least one trunk wire is two, the two trunk wires extend in two directions perpendicular to each other, the two trunk wires cross at the central point to define four layout areas, and the island portions are distributed evenly within the layout areas.

4. The touch electrode unit as claimed in claim 3, wherein each of the branch wires extends along one of the two directions.

5. The touch electrode unit as claimed in claim 3, wherein each of the layout areas is a triangular layout area having a right angle toward the central point.

6. The touch electrode unit as claimed in claim 5, wherein the island portions are distributed in an array manner within the triangular layout areas.

7. The touch electrode unit as claimed in claim 6, wherein a number of the island portions arranged along one of the two directions is gradually decreasing in the other of the two directions away from the central point.

8. The touch electrode unit as claimed in claim 1, wherein each of the island portions is formed into a solid block shaped as a regular polygon.

9. The touch electrode unit as claimed in claim 8, wherein each of the island portions is formed into a regular quadrilateral and has four right angles, and at least one of two ends of the branch wires is connected between adjacent two of the right angles of each of the island portions.

10. The touch electrode unit as claimed in claim 9, wherein a length of each of four edges of each of the island portions formed as the regular quadrilateral is greater than a width of each of the branch wires, and the width of each of the branch wires is less than a width of the trunk wire.

11. The touch electrode unit as claimed in claim 1, wherein the trunk wire, the island portions, and the branch wires are formed of a transparent conductive material.

12. A touch panel, comprising a plurality of touch electrode units, wherein the touch electrode units are connected in series to form a plurality of first electrode strings and a plurality of second electrode strings, the first electrode strings are arranged in parallel along a first direction, the second electrode strings are arranged in parallel along a second direction perpendicular to the first direction, and the touch electrode units in the first electrode strings and the touch electrode units in the second electrode strings are arranged in an interlaced manner and insulated from each other; and
wherein one of the touch electrode units comprises:
at least one trunk wire;
a plurality of island portions distributed evenly around at least one of two sides of the trunk wire; and
a plurality of branch wires connecting the island portions to each other and connecting the trunk wire to a part of the island portions close to the trunk wire, wherein a plurality of hollow portions are formed between the branch wires, the island portions, and the trunk wire.

13. The touch panel as claimed in claim 12, wherein a number of the at least one trunk wire is two or more, and the two or more trunk wires cross each other at a central point.

14. The touch panel as claimed in claim 13, wherein the number of the at least one trunk wire is two, the two trunk wires extend in two directions perpendicular to each other, the two trunk wires cross at the central point to define four layout areas, and the island portions are distributed evenly within the layout areas.

15. The touch panel as claimed in claim 14, wherein each of the branch wires extends along one of the two directions.

16. The touch panel as claimed in claim 14, wherein each of the layout areas is a triangular layout area having a right angle toward the central point.

17. The touch panel as claimed in claim 16, wherein the island portions are distributed in an array manner within the triangular layout areas.

18. The touch panel as claimed in claim 17, wherein a number of the island portions arranged along one of the two directions is gradually decreasing in the other of the two directions away from the central point.

19. The touch panel as claimed in claim 12, wherein each of the island portions is formed into a solid block shaped as a regular polygon.

20. A touch display, comprising the touch panel as claimed in claim 12.
